(19) United States
(12) Patent Application Publication
(10) Pub. No.: US 2025/0313469 A1
(43) Pub. Date: Oct. 9, 2025

(54) Plasma Process for Nitrate Production

(71) Applicant: Sergey Macheret, Lafayette, IN (US)

(72) Inventor: Sergey Macheret, Lafayette, IN (US)

(73) Assignee: US Plasma Engineering LLC, Lafayette, IN (US)

(21) Appl. No.: 18/887,594

(22) Filed: Sep. 17, 2024

Related U.S. Application Data
(60) Provisional application No. 63/592,582, filed on Oct. 24, 2023.

(51) Int. Cl. C01B 21/20

(52) U.S. Cl. CPC C01B 21/203

(57) ABSTRACT

A plasma process for synthesis of nitrates and nitrites is described. The proposed process utilizes an electrical discharge in a two-phase gas-liquid mixture of oxygen, nitrogen and water droplets, the average droplet size being less than 200 micrometers. The presence of microdroplets changes the electrical discharge, particularly by creating local regions of enhanced electric field near the droplet surface where the plasma-induced chemical reactions are intensified. Further, the microdroplets suppress the reverse chemical reaction and enhance the direct reaction of nitrate/nitrite formation, thus increasing the amount of product for the same input energy and decreasing the energy cost per unit product. The proposed process thus enables plasma production of nitrate fertilizer with reduced energy costs.

### CROSS-REFERENCE TO RELATED APPLICATIONS

This application is based on and claims benefit to U.S. provisional application 63/592,582 filed on Oct. 24, 2023.

### BACKGROUND OF THE INVENTION

Nitrogen is essential for plant growth and reproduction and is a key component in the production of energy in plant cells. Nitrogen fertilizer production is critically important to help crops grow stronger and healthier, and to increase yield. Plants cannot consume nitrogen directly from the atmospheric air, instead absorbing nitrogen from the soil in the form of a chemical compound. Thus, nitrogen fixation to produce ammonia, nitrate or other nitrogen bearing chemical compounds is the key to producing nitrogen fertilizers.

The Birkeland-Eyde process was historically the first process that enabled production of plant fertilizers via synthesis of nitrate, but it was quickly overtaken by the Haber-Bosch process of nitrogen fixation in the form of ammonia. The Haber-Bosch process is an industrial process to fix nitrogen through ammonia production by a reaction with hydrogen using metal catalysts under conditions of high temperatures and pressures. The Haber-Bosch process or its modification is today the primary process of nitrogen fixation. However, the process consumes large amounts of energy and natural resources and generates substantial environmental pollution. Indeed, the process requires natural gas as a raw material, and three to five percent of the world's natural gas production. corresponding to about 2% of the total world annual energy supply, is consumed in the Haber-Bosch process. In addition, about 500 million metric tons of CO₂, 120 million tons of NO₂ and over 80 million tons of NH₃ are emitted globally each year in the Haber-Bosch process.

Furthermore, the demand for local (i.e. decentralized) fertilizer production and new applications for nitrogen species in conjunction with renewable energy generation call for innovative and sustainable technologies for nitrogen fixation in the form of NOₓ, nitrates, or NH₃. Among several alternatives. plasma assisted nitrogen fertilizer production is one of the most promising technologies.

Until recently, plasma processes were generally only studied in the gas phase, whereas a practical nitrate fertilizer should be liquid or solid. Researchers have studied and evaluated different plasma types, reactor shapes, voltage and current profiles, and catalysts for their effect on nitrogen oxide or ammonia production and the yield of plasma activated gas (PAG). Several research groups have examined how PAG interacts with water and confirmed the presence of nitric acid in the water interacting with PAG.

Low temperature, weakly ionized plasmas, such as those in fluorescent lights, electric arcs and sparks, as well as in other types of electrical discharges, possess unique properties. Among those properties is the fact that, although the gas as a whole is relatively cold (has low mean energy per molecule), the free electrons inside it are very hot (high mean kinetic energy of the electrons), with the electron temperature on the order of 10,000-50,000 K. These hot electrons can excite and dissociate molecules and initiate chemical reactions, thus efficiently channeling the electric energy input into the desired product. Moreover, in these low-temperature thermally nonequilibrium plasmas, the energy input is channeled through electron-molecule collisions into the molecules' rotational and vibrational modes. The excitation of the vibrational energy of molecules can efficiently promote endothermic chemical reactions at low or relatively low gas temperature.

The unique ability of plasmas to efficiently channel electrical energy into generation of chemical species can be used for nitrogen fertilizer production. Plasma in the air is known to produce oxides of nitrogen. When oxides of nitrogen are diluted in water, these plasma-produced nitrogen oxides produce a weak nitric acid, i.e. a liquid nitrate fertilizer. Such technology has important inherent advantages compared with the Haber-Bosch process:
1) No raw materials are needed: the fertilizer is made from air and water;
2) No carbon monoxide and/or dioxide are produced;
3) The plasma process can be decentralized because it is more scalable, e.g. it can operate independently in regional production facilities or at individual farms;
4) The plasma process directly produces liquid (aqueous) nitrate which can be readily consumed by the plants. Although one agricultural practice is to apply ammonia (NH₃) or some form of ammonia which is produced today by using the Haber-Bosch process, ammonia itself is not directly consumed by the plant root system; instead, a two-step bacteria-driven biological process converts the ammonia to aqueous nitrate (aqueous NO₃⁻), and it is the nitrate which is consumed by the plant.

Despite these advantages, the plasma production of nitrate fertilizer has not yet been developed into a practical technology even though the plasma-based Birkeland-Eyde process had been developed prior to the Haber-Bosch cycle. The principal reason is that the Haber-Bosch process is more efficient when compared to the Birkeland-Eyde plasma production of nitrates. However, because of the explosive increase in demand for fertilizers in the past few decades, there are concerns about sustainability, consumption of hydrocarbon resources, and greenhouse gas emission; thus, there is a need for alternative nitrogen fixation processes.

Although the Birkeland-Eyde (BE) plasma process was the first commercial nitrogen fixation process, it was not a thermally nonequilibrium process, but rather a thermally equilibrium process. It was based on an electrical arc formed between two coaxial water-cooled copper tube electrodes powered by a high voltage alternating current. A strong static magnetic field generated by a nearby electromagnet caused the arc to rapidly rotate and thus to form a thin plasma disc. The plasma temperature in the disc was in excess of 3000° C. Air was blown through this arc, causing some of the nitrogen to react with oxygen forming nitric oxides. The nitrogen dioxide was then absorbed into water in a series of packed column or plate column absorption towers. The plasma in the BE process was close to thermodynamic equilibrium. severely limiting the energy efficiency. Another major source of inefficiency was an incomplete absorption of the gaseous nitrogen dioxide in the absorption column; both of these disadvantages are resolved with the present invention.

One of the key metrics to determine the viability of any plasma-based nitrogen fixation production of fertilizers is the energy cost which can be expressed as the energy (typically measured in electron-volts, or eV) spent per one nitrate ion.

The energy cost of Haber-Bosch process is about 5-8.5 eV per ammonia molecule. However, when additional costs and losses associated with production and transportation of natural gas, conversion of ammonia into nitric acid. transportation, etc., are taken into account. the equivalent energy cost of Haber-Bosch process is considerably higher than that. A plasma process with an energy cost comparable with that of the Haber-Bosch process, when combined with the inherent advantages of plasma processes listed above. could be competitive with the Haber-Bosch process.

The minimum energy cost per nitric oxide molecule made in thermally nonequilibrium air plasmas was calculated as approximately 3 eV. The three key assumptions in the theoretical calculations, translating into the necessary conditions for the plasma process, are: the energy input and the electric field strength should be such that most of the discharge energy is used for vibrational excitation of nitrogen molecules, the gas temperature has to be below about 800-1200 K in order to maintain high vibrational-translational nonequilibrium, and the reverse chemical reactions destroying the product have to be suppressed. The actual energy cost per nitrate ion in various plasma devices reported in the literature range from as high as 4.4×10⁵ eV/ion down to about 120-150 eV/ion. These energy costs are considerably higher than the theoretical minimum energy cost.

### BRIEF SUMMARY

It is an object of the present invention to modify the plasma process so that the electrical discharge (plasma) operates in a two-phase mixture of air with water micro- or nanodroplets, which can ensure and promote conversion of nitrogen oxides to aqueous nitrate (NO₃⁻) and nitrite (NO₂⁻) within the plasma reaction zone, suppress the reverse chemical reactions that would destroy the product, and assist in maintaining thermal nonequilibrium by keeping the gas phase cool. This process modification is critical to the reduction of energy cost, all other variables being the same. All prior research and reported experimental results have created plasma in the gas phase. Water sprays or operating plasmas in contact with water have been used just to capture the gas-phase products, or to cool the gas phase. The present invention cannot be explained by or reduced to those works and disclosures. Indeed, in prior plasma studies and disclosures, generation of NOₓ occurs in the gas phase only, whereas in this invention, the micro- or nanodroplet phase is an active and essential participant in the overall chemical plasma process, which enables plasma production of nitrate fertilizer with lower energy costs. Moreover, the presence of liquid droplets changes the electrical discharge itself, particularly by creating local regions of enhanced electric field near the droplet surface where the plasma-induced chemical reactions are intensified.

The micro- or nanodroplets are thus a critical element of the system acting as an inherent participant in the plasma chemical process. The most important advantages of such a system and process are as follows:
1) Due to the high solubility of nitrate (NO₃⁻) and nitrite (NO₂⁻) in water, the thermodynamically minimal energy cost of making those products from gas-phase nitrogen and oxygen is lower than the thermodynamically minimal energy cost of making gas-phase oxides of nitrogen.
2) In the reaction zone, during the reaction which creates the nitrogen oxides, the micro- or nanodroplets suppress the reverse chemical reaction and enhance the direct reaction of nitrate/nitrite formation, thus increasing the amount of product for the same input energy and decreasing the energy cost per unit product.
3) The plasma chemical reactions occur not just in the gas phase, but also, and essentially, at the interface between the gaseous plasma and the liquid micro-or nanodroplets. As the species produced in the gas phase go in their transformed form into the liquid inside the reaction zone, the chemistry in the gas phase is favorably affected so that more products are produced, and reverse chemical reactions are further suppressed.
4) The water microdroplets help in cooling the plasma so that the gas temperature is kept below about 800-1200 K, which is essential for maintaining vibrational-translational nonequilibrium required for energy-efficient plasma chemical process, thus allowing for a higher energy density in order to promote further chemical reactions and thus to make nitrogen oxides and nitrate more efficiently.

The water droplet size is a significant parameter for droplets (water mist) to participate in the chemical reactions. If the droplet diameter is around 200 micrometers or less, the water droplets start to participate significantly in the overall chemical process. Reducing the droplet diameter increases the interaction area for a given volume of air and water and dramatically increases the rates of transport of chemical products from the plasma/gas to the liquid phase.

Thus. the key element of this invention is to create a two-phase mixture of gas and very small liquid droplets and to inject the mixture into plasma. In most methods of producing liquid droplets. droplets of various sizes are generated, and within the present invention, the average diameter of the droplets should be smaller than 200 micrometers, and preferably less than about 10 micrometers, including but not limited to nanometer-scale droplet sizes.

As employed herein, the term “electrical discharge” can be a dielectric barrier discharge (DBD), gliding arc discharge, corona discharge, radio frequency discharge, pulsed radio frequency discharge, or other discharges. More specifically, although electrical discharge plasmas generated at low gas pressure can be volumetrically-uniform (‘diffuse’), atmospheric-pressure discharges in air and air-water mixtures consist of one or more plasma filaments which, depending on the conditions, are called arcs, sparks, leaders, or streamers.

### BRIEF DESCRIPTION OF THE DRAWINGS

FIG. 1 is a process block diagram of a method to synthesize nitrates and nitrites in plasma according to the present disclosure.

FIG. 2 is a modification to process block diagram of FIG. 1.

### DETAILED DESCRIPTION

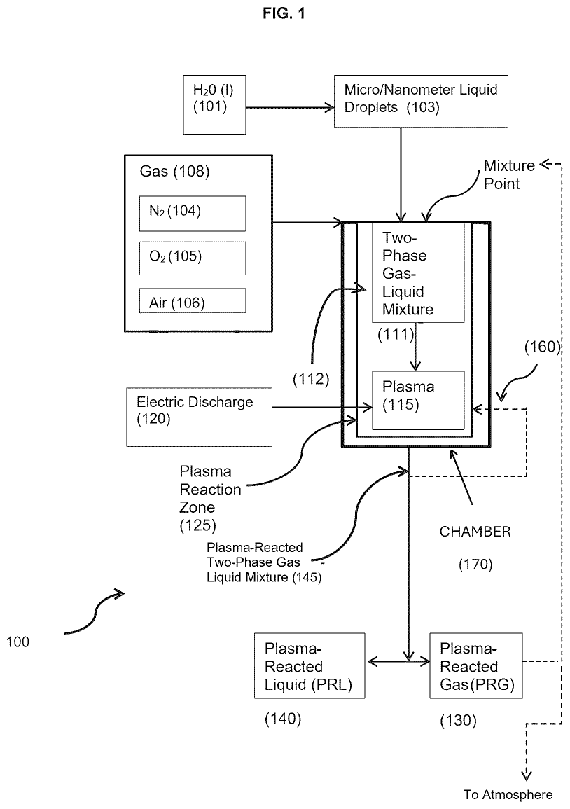

FIG. 1 is a process block diagram showing the disclosed process step 100 which shows the pathway towards a more efficient thermodynamically nonequilibrium nitrogen fixation process. Liquid water 101 is first made into liquid microdroplets or nanodroplets 103 (hereafter referred to as microdroplets) less than 200 micrometers in average diameter, and preferably less than 10 micrometers in average diameter, including but not limited to nanometer-scale droplet sizes. Liquid microdroplets 103 are added to gas 108 by mixing at mixture point 110 of a chamber 170. The chamber 170 could be made of any solid material (e.g. metal. a high resistance plastic or polymer) being able to withstand pressure, plasma temperatures, and acidic environment. The chamber 170 should have an opening. or a multitude of openings, to accept the mixture of liquid microdroplets 103 and gas 108. Gas 108 can be air 106. Gas 108 can also be just O₂ 105, N₂ 104, or any ratio of the two.

Mixture point 110 is either prior to, or within physical space 112 inside the chamber 170 where an electrical discharge 120 creates a plasma 115 in plasma reaction zone 125. The electrical discharge 120 can be a dielectric barrier discharge DBD, gliding arc discharge, corona discharge, radio frequency discharge, pulsed radio frequency discharge, or other discharges. The preferred electrical discharge 120 is a time modulated filamentary electrical discharge, so that a certain optimal amount of energy from the electrical discharge is received by each small volume of the two-phase gas-liquid mixture 111 during its residence time in the plasma reaction zone 125 to create a gas-droplet mixture containing aqueous nitrate (NO₃⁻) and nitrite (NO₂⁻). For purposes of this invention, a volume is a part. no matter how small, of a two-phase gas-droplet mixture. For example, a volume can contain multiple droplets, or it can contain only one droplet or no droplets. Further, for purposes of this invention, a residence time is the time a small volume of the generated two-phase gas-liquid mixture spends in the plasma-reaction zone. And yet further, it is also preferred that the electrical discharge 120 is that of a filamentary discharge which consists of multiple plasma filaments, or channels, as known in the art. These multiple plasma filaments (channels) can coexist in time but can be separated in space within the plasma reaction zone 125. The multi-filament discharge is one or more of a spark, streamer, or leader. And yet further, one or a few plasma filaments (channels) exist at any instant during the ‘on’ period of the power supplied to the plasma, but multiple plasma filaments (channels) are created in the plasma reaction zone 125 during the residence time of the two-phase gas-liquid mixture 111. Although not shown, each of the one or more multi-filament electrical discharges 120 contains one or more electrodes (not shown), and further the type of electrode that is preferred is that of a pin.

The plasma 115 causes aqueous nitrate (NO₃⁻) and nitrite (NO₂⁻) (hereafter referred to as nitrate/nitrite) to be produced from the two-phase gas-liquid mixture 111. The nitrates/nitrites leave the plasma reaction zone 125 in a plasma-reacted liquid, PRL 140, and plasma-reacted gas, PRG 130. These plasma-reacted liquid, PRL 140, microdroplets are collected as an aqueous synthetic nitrogen compound either at another opening (or a multitude of openings) of the chamber 170 or directly within the chamber 170. The plasma-reacted gas, PRG 130, can be either exhausted to atmosphere or recirculated back to mixture point 110, or a combination of the two can be used.

The energy from the electrical discharge 120 received by the two-phase gas-liquid 111 mixture is such that the mean gas temperature in the plasma reaction zone 125 does not exceed 1200 K, and preferably does not exceed 800 K, in order to maintain thermal nonequilibrium in the plasma, reduce the overall energy cost of the process and to suppress reverse chemical reactions that would destroy the product.

Time-modulating the electric input to the electrical discharge 120 to the electrodes (not shown) is an inherent element of this invention. Time-modulating means that the electrical input to the discharge consists in repetition of a cycle such that in each cycle there is an active (electric input is on) time interval followed by a pause (electric input is off). Time-modulating the electrical energy input and the durations of the active and pause time intervals are such that an optimal amount of energy, 0.5-1.5 eV per gas molecule is received by each small volume of the two-phase gas-liquid mixture 111 from the electrical discharge 120, and that the gas temperature within the plasma reaction zone 125 does not exceed 1200 K, in order to maximize the energy efficiency of producing the nitrate or other nitrogen compound product. This temperature can be achieved and maintained by controlling the flow rates of both gas and water and by controlling and time-modulating the electrical energy input.

As shown in FIG. 1, plasma-reacted two-phase gas liquid mixture 145 can pass more than once (shown by representative dashed line 160 through the same plasma reaction zone 125) prior to being collected as a plasma-reacted liquid 140.

To reduce the energy cost of the thermodynamically nonequilibrium process, the average diameter of liquid microdroplets 103 should be smaller than 200 micrometers, and preferably between 0.1 to 10 micrometers. The smaller droplet size is what causes plasma chemical reactions and reactions at the plasma-liquid interface that produce nitrate and nitrite to be promoted and those chemical reactions that destroy the nitrate and nitrite to be suppressed, the gas-liquid interface in two-phase gas-liquid mixture 111 further promoting the production of aqueous nitrate (NO₃⁻) and nitrite (NO₂⁻) by changing the chemistry within the plasma 115.

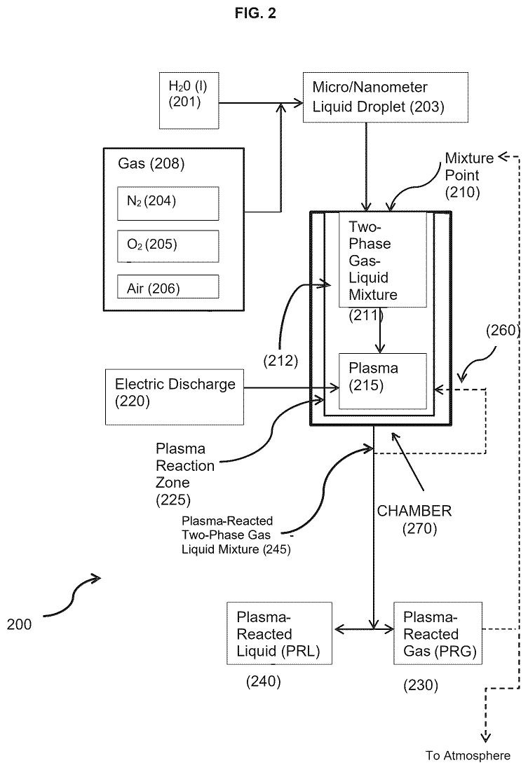

FIG. 2 shows essentially the same process block diagram as FIG. 1 with some modifications for clarity. The nomenclature within process step 100 will be the same if the last two digits are the same. One will notice that all components are the same as in FIG. 1 except that gas 208 and liquid water 201 are conjoined. This represents a process arrangement 200 where gas 208 is used to form microdroplets 203, such as occurs in pressure spray nozzles or the like which pressurize the gas 208 which then causes liquid water 201 to form microdroplets 203. Means for creating liquid microdroplets or nanodroplets 103, 203 can be ultrasonic, high-pressure atomization, fogging, or other known techniques.

The embodiments have thus far described a process for minimizing the amount of energy to create nitrate that has not been previously possible using plasma. Other process steps or variations will be obvious to those in the field of plasma processes and are included within the scope of the claims.

What is claimed is:

1. A method of synthesis of nitrates and nitrites, comprising:
a. Providing a device comprising of a chamber with an opening to accept a gas and liquid flow, a means to generate an electrical discharge inside said chamber, and a means to remove a gas and liquid flow;
b. generating water droplets with an average diameter smaller than 200 micrometers;
c. dispersing said water droplets with a gas containing oxygen and nitrogen to form a volume of two-phase gas-liquid mixture and injecting said volume of two-phase gas-liquid mixture through the opening to accept a gas and liquid flow in said chamber;
d. generating the electrical discharge to create a plasma inside said chamber, thus initiating a reaction between oxygen and nitrogen and leading to a synthesis of nitrates and nitrites;
e. collecting a plasma-reacted liquid containing said nitrates and nitrites using the means to remove a gas and liquid flow.

2. The method of claim 1, wherein the means to generate an electrical discharge includes a time-modulated electrical energy input and optimization of said energy input per gas molecule for a highest energy efficiency of the synthesis of nitrates and nitrites.

3. The method of claim 1, wherein the means to generate an electrical discharge results in a single-filament or multi-filament discharge.

4. The method of claim 1, wherein the means to generate the electrical discharge contains one or more electrodes.

5. The method of claim 1, wherein the means to generate electrical discharge contains a pin-type electrode.

6. The method of claim 1, wherein the electrical discharge is one or a multitude of a spark, a streamer, or a leader.

7. The method of claim 1, wherein multiple volumes of two-phase gas-liquid mixture are generated to pass through the opening to accept a gas and liquid flow of said chamber.

8. The method of claim 1, wherein the time-modulated energy input is such that each volume of the two-phase gas-liquid mixture encounters the electrical discharge in a fixed location at least once during a residence time of said volume in the plasma reaction zone.

9. The method of claim 1, wherein the electrical discharge created in a plasma reaction zone is generated in different locations with the time-modulated energy input so that each volume of the two-phase mixture encounters the electrical discharge at least once during the residence time of said volume in the plasma reaction zone.

10. The method of claim 1, wherein the electrical discharge energy received by the two-phase gas-liquid mixture in the plasma reaction zone is 0.5-1.5 eV per gas molecule.

11. The method of claim 1, wherein the mean gas temperature in the plasma reaction zone is controlled with the time-modulated energy input not to exceed 1200 K.

12. The method of claim 1, further comprising:
a. passing the plasma-reacted liquid and a plasma-reacted gas more than one time through the plasma reaction zone prior to being collected as the plasma-reacted liquid.

13. The method of claim 1, wherein the gas flow includes air.

14. The method of claim 1, wherein said means to remove the gas and liquid flow is another opening in the chamber.

15. The method of claim 1, wherein said means to remove the gas and liquid flow is a multitude of openings in the chamber.

16. The method of claim 1, wherein said means to remove the gas and liquid flow is a container inside the chamber.
